(19) United States
(12) Patent Application Publication
(10) Pub. No.: US 2021/0090111 A1
(43) Pub. Date: Mar. 25, 2021

(54) METHOD AND SYSTEM FOR RECOMMENDING PRODUCTS TO SENDERS FOR PRESENTING TO RECIPIENTS

(71) Applicant: MASTERCARD INTERNATIONAL INCORPORATED, Purchase, NY (US)

(72) Inventors: Aditi Garg, Mumbai (IN); Priyanshee Palriwala, Ahmedabad (IN); Dinesh Kumar Lal, Gurgaon (IN)

(73) Assignee: MASTERCARD INTERNATIONAL INCORPORATED, Purchase, NY (US)

(21) Appl. No.: 17/024,276

(22) Filed: Sep. 17, 2020

(30) Foreign Application Priority Data
Sep. 19, 2019 (SG) 10201908722S

(51) Int. Cl. G06Q 30/02; G06Q 30/06

(52) U.S. Cl. CPC G06Q 30/0214; G06Q 30/0639; G06Q 30/0224; G06Q 30/0631

(57) ABSTRACT

A method for recommending products to a sender for presenting to a recipient includes registering, by a server, first and second payment modes indicative of first and second purchase histories of the first sender and the recipient, respectively. The server determines a set of product categories that maps to the second purchase history and generates a list of products associated with the determined set of product categories. The server filters the generated list based on a set of rules such that a first plurality of products already purchased by the recipient are excluded from the generated list. The server renders a first user interface on a first user device of the sender to display the filtered list that includes one or more products recommended to the sender for presenting to the recipient. The displayed one or more products are selectable by the sender for presenting to the recipient.

### FIELD

Various embodiments of the disclosure relate generally to methods and systems for recommendation of products. More particularly, various embodiments of the present disclosure relate to a method and a system for recommending products to a sender for presenting to a recipient.

### BACKGROUND

Gifting constitutes an integral part of any event, particularly an event that is of personal significance to a user. Examples of such events may include birthdays, wedding anniversaries, work anniversaries, or the like. The advent of e-commerce websites and internet retailers has led impetus to online gifting, allowing users from various parts of the globe to gift products and services to their family, friends, or colleagues.

Various systems exist for providing recommendations, of products, to users (i.e., senders) for presenting to a recipient. Such systems, typically, monitor online activities of the sender and the recipient for providing recommendations. Online activities may include online pages liked, shared, or followed by the recipient and the sender, search histories of the recipient and the sender, products placed by the recipient in a virtual shopping carts of an e-commerce website, or the like. However, such systems generally have no awareness of an actual purchase history of the recipient and the sender, and may not be able to accurately deduce spending patterns of the recipient and the sender. Since, the systems are restricted to monitoring the online activity of the recipient, the recommendations provided by these systems may be based on an incomplete knowledge of preferences and the purchase history of the recipient. Consequently, the recommendations provided by such systems may include products already purchased by the recipient. Gifts to the recipient that include such products may lack novelty for the recipient, thus inconveniencing both the recipient and the senders.

In light of the foregoing, there is a need for a technical solution that solves the abovementioned problems, and provides relevant product recommendations to a sender for presenting to a recipient.

### SUMMARY

In an embodiment of the present disclosure, a method for recommending one or more products to a first sender for presenting to a recipient, is provided. The method includes registering, by a server, first and second payment modes of the first sender and the recipient, respectively, with a service application hosted by the server. The first and second payment modes are associated with first and second purchase histories of the first sender and the recipient. An event requiring recommendation of the one or more products to the first sender for presenting to the recipient is detected by the server. Upon the detection, a set of product categories that maps to the second purchase history is determined by the server. The second purchase history of the recipient indicates a first plurality of products purchased by the recipient. A list including a second plurality of products that are associated with the determined set of product categories is generated by the server. The generated list is filtered, by the server, based on a set of rules to obtain the one or more products for recommending to the first sender. One of the set of rules pertains to exclusion of the first plurality of products from the generated list. A user interface is rendered, by the server, on a first user device of the first sender, for displaying the filtered list including the one or more products. The displayed one or more products are selectable by the first sender for presenting to the recipient.

In another embodiment of the present disclosure, a system for recommending one or more products to a first sender for presenting to a recipient is provided. The system includes a server that is configured to register, with a service application hosted by the server, first and second payment modes of the first sender and the recipient, respectively. The first and second payment modes are associated with first and second purchase histories of the first sender and the recipient, respectively. The server detects an event requiring recommendation of the one or more products to the first sender for presenting to the recipient. The server determines a set of product categories that maps to the second purchase history. The server generates a list including a second plurality of products that are associated with the determined set of product categories. The server filters the generated list based on a set of rules to obtain the one or more products for recommending to the first sender. One of the set of rules pertains to exclusion of the first plurality of products from the list. The server renders a user interface on a first user device of the first sender for displaying the filtered list including the one or more products. The displayed one or more products are selectable by the first sender for presenting to the recipient.

### BRIEF DESCRIPTION OF THE DRAWINGS

Various embodiments of the present disclosure are illustrated by way of example, and not limited by the appended figures, in which like references indicate similar elements, and in which:

FIG. 1 is a block diagram that illustrates an exemplary environment for recommending products to a sender for presenting to a recipient, in accordance with an exemplary embodiment of the present disclosure;

FIGS. 2 represents a process flow diagram that illustrates an exemplary scenario for registering a user with the recommendation server 110, in accordance with an exemplary embodiment of the present disclosure;

FIGS. 3 represents another process flow diagram that that illustrates an exemplary scenario for linking virtual accounts of registered users, in accordance with an exemplary embodiment of the present disclosure;

FIGS. 4A-4C, collectively represent a process flow diagram that illustrates an exemplary scenario for recommending products to one or more senders for presenting to a recipient, in accordance with an exemplary embodiment of the present disclosure;

FIG. 5 represents an exemplary scenario that illustrates UI screens of a service application of FIG. 1, in accordance with an exemplary embodiment of the present disclosure;

FIG. 6 represents an exemplary scenario that illustrates UI screens of the service application, in accordance with another exemplary embodiment of the present disclosure;

FIG. 7 is a block diagram that illustrates a recommendation server of FIG. 1, in accordance with an exemplary embodiment of the present disclosure;

FIG. 8 is a flow chart that illustrates a method for registering various users with a service application hosted by the recommendation server of FIG. 1, in accordance with an exemplary embodiment of the present disclosure;

FIGS. 9A-9C, collectively represent a flow chart that illustrates a method for recommending products to a sender for presenting to a recipient, in accordance with an exemplary embodiment of the present disclosure;

FIG. 10 represents a high-level flow chart that illustrates the method for recommending one or more products to a sender for presenting to a recipient, in accordance with an exemplary embodiment of the present disclosure; and

FIG. 11 is a block diagram that illustrates system architecture of a computer system, in accordance with an exemplary embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

Recommendation systems may not be aware of an actual purchase history of a recipient. Thus, product recommendations provided, to a sender, by these recommendation systems may include products that are already purchased by the recipient. As a result, the sender may end up gifting to the recipient a product that is already purchased by the recipient. Thus, both the recipient and the sender may be inconvenienced.

Various embodiments of the present disclosure provide a method and a system that solve the abovementioned problem by recommending products to a sender, for presenting to a recipient, based on an actual purchase history of the recipient. The system of the present disclosure includes a server that hosts a service application for providing a product recommendation service. Examples of the server may include, but are not limited to, an issuer server, a third-party merchant server, a social media server, an e-commerce server, a merchant aggregator server, or the like. The sender and the recipient may request to register respective first and second payment modes with the recommendation server. The first and second payment modes may be indicative of first and second purchase histories of the sender and the recipient, respectively. Based on the registration, the server may create first and second virtual accounts for the sender and the recipient, respectively. Each virtual account may be associated with a gifting network. Based on permissions granted by the recipient, the server may add the sender to a first gifting network of the recipient, and link the second virtual account to the first virtual account. On the addition of the sender to the first gifting network, the server is allowed to access the second purchase history of the recipient for providing product recommendations to the sender for the recipient.

The server may detect an upcoming event that requires recommendation of one or more products to the sender for presenting to the recipient. Based on the detection of the upcoming event, the server may determine a set of product categories that maps to the second purchase history of the recipient. The second purchase history may be indicative of products already purchased by the recipient. Based on the determined set of product categories, the server may generate a list including products that are associated with the determined set of product categories. Based on a set of rules, the server filters the generated list to obtain the one or more products for recommending to the sender. Based on one of the set of rules, the server may exclude the products that are already purchased by the recipient from the generated list to obtain the filtered list. The filtered list may be displayed on a user interface rendered by the server on a first user device of the sender. The displayed filtered list may include one or more products, selectable by the first sender for presenting to the recipient.

Thus, the method and system of the present disclosure provide recommendations of one or more products to the sender for presenting to the recipient, based on an actual purchase history of the recipient. Thus, the method and system of the present disclosure not only personalizes the product recommendations for the recipient but also prevents duplicate gifting to the recipient.

### Terms Description (in Addition to Plain and Dictionary Meaning)

Sender is a user who presents (or gifts) one or more products to another user (i.e., recipient) based on an event associated with the other user. In a scenario where a first user gifts a first product to second user, the first user is referred to as the sender.

Recipient is a user who is presented or gifted one or more products by a sender for an event associated with the recipient. In a scenario where a first user gifts a first product to second user, the second user is referred to as the recipient.

Product category refers to a type or classification of a product. For example, product category of a smartphone may be ‘consumer electronics’. Likewise, product category of a shirt may be ‘apparel’.

Set of rules refers to criteria applied for filtering a list including a plurality of products. The set of rules may be applied to obtain a filtered list including one or more products that may be recommended to a sender for presenting to a recipient. Each of the set of rules may act as a filtration criterion. For example, a rule may pertain to exclusion of the products already purchased by or gifted to the recipient. Consequently, the products that are purchased by or gifted to the recipient are excluded from the list to obtain the filtered list.

Payment mode is means of payment that allows a user to perform transactions for purchasing products and/or services from merchants. Examples of a payment mode may include a transaction card, digital wallet, or the like.

Server is a physical or cloud data processing system on which a server program runs. The server may be implemented in hardware or software, or a combination thereof In one embodiment, the server may be implemented in computer programs executing on programmable computers, such as personal computers, laptops, or a network of computer systems. The server may correspond to one of a recommendation server, an acquirer server, a payment network server, or an issuer server.

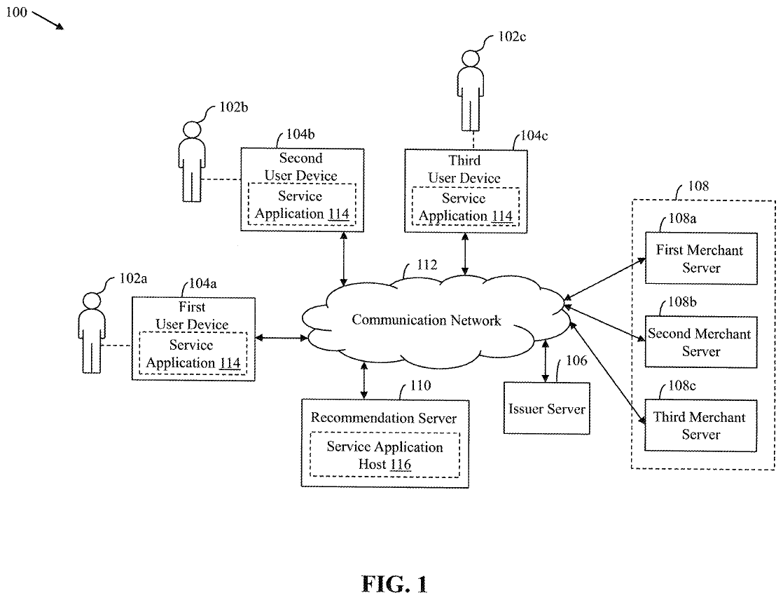

FIG. 1 is a block diagram that illustrates an exemplary environment 100 for recommending products to a sender for presenting to a recipient, in accordance with an exemplary embodiment of the present disclosure. The environment 100 includes first through third users 102a-102c (hereinafter, collectively referred to as ‘the users 102’) in possession of first through third user devices 104a-104c (hereinafter, collectively referred to as ‘the user devices 104’), respectively. The environment 100 further includes an issuer server 106, first through third merchant servers 108a-108c (hereinafter, collectively referred to as ‘the merchant servers 108’), and a recommendation server 110. The user devices 104, the issuer server 106, the merchant servers 108, and the recommendation server 110 may communicate with each other by way of a communication network 112 or through separate communication networks established therebetween.

The first user 102a is an individual, who is associated with a first payment mode. In one example, the first payment mode may be a first transaction card linked to a payment account of the first user 102a that is maintained at a financial institution, such as a first issuer. Examples of the first transaction card may include, but are not limited to, a debit card, a credit card, or a prepaid card. In another example, the first payment mode may be a first digital wallet maintained at the first issuer. Examples of the first digital wallet may include, but are not limited to, Apple Pay Cash®, or the like. In a non-limiting example, it is assumed that the first payment mode is the first transaction card. The first payment mode may have been utilized by the first user 102a to purchase various products and/or services from various merchants. Thus, the first payment mode may be associated with a first purchase history of the first user 102a that indicates the products and/or the services purchased by the first user 102a using the first payment mode. In other embodiments, the first purchase history may also be indicative of transactions performed (e.g., money deposited in the payment account) by the way of the payment account (e.g., netbanking) that is linked to the first payment mode. For example, the first purchase history may be indicative of a monthly income of the first user 102a or an amount present in the payment account.

The first user device 104a is a communication device of the first user 102a. Examples of the first user device 104a may include a smartphone, a personal computer, a laptop, a tablet, a phablet, or the like. The first user device 104a may include suitable logic, circuitry, interface, and/or code, executable by the circuitry, that is configured to execute various service applications, for example, a service application 114. The service application 114 may be a mobile application or a web-based application hosted by the recommendation server 110. The first user 102a may register with the recommendation server 110 to create a first virtual account for accessing the service application 114. The first user device 104a may be utilized by the first user 102a for registering the first payment mode with the service application 114 hosted by the recommendation server 110. Based on the registration, the first payment mode may be added to the first virtual account. By way of the first virtual account, the first user 102a may avail a product recommendation service offered by the recommendation server 110.

The second user 102b is an individual, who is associated with a second payment mode. The second payment mode may be a second transaction card or a second digital wallet. In the current embodiment, it is assumed that the second payment mode is the second transaction card linked to a payment account, which is maintained at the first issuer. The second payment mode may be indicative of a second purchase history of the second user 102b. The second purchase history indicates the products and/or the services purchased or the transactions made by the second user 102b using the second payment mode.

The second user device 104b is a communication device of the second user 102b. The second user device 104b is functionally similar to the first user device 104a. Examples of the second user device 104b may include a smartphone, a personal computer, a tablet, a phablet, or the like. The second user device 104b may include suitable logic, circuitry, interface, and/or code, executable by the circuitry, that is configured to execute various service applications, for example, the service application 114. The second user 102b may access the service application 114 that runs or is executed on the second user device 104b.

Similarly, the third user 102c is an individual, who is associated with a third payment mode. The third payment mode may be a third transaction card or a third digital wallet. In a non-limiting example, it is assumed that the third payment mode is the third transaction card linked to a payment account, maintained at the first issuer, of the third user 102c. It will be apparent to those of skill in the art that the third payment mode may be maintained at an issuer other than the first issuer. The third payment mode may be associated with a third purchase history of the third user 102c. The third purchase history indicates the products and/or the services purchased or the transactions made by the third user 102c using the third payment mode.

The third user device 104c is a communication device of the third user 102c. The third user device 104c is functionally similar to the first and second user devices 104a and 104b. The third user device 104c may include suitable logic, circuitry, interface, and/or code, executable by the circuitry, that is configured to execute various service applications, for example, the service application 114. The third user 102c may access the service application 114 that runs or is executed on the third user device 104c.

It will be apparent to those of skill in the art that each of the users 102 may be associated with any number of different payment modes, without deviating from the scope of the disclosure.

The issuer server 106 is a computing server operated by the first issuer. The first issuer may be a financial institution that manages payment accounts and/or digital wallets of multiple users (such as the users 102). Details of the payment accounts established with the first issuer may be stored as account profiles by the issuer server 106. Each account profile may be indicative of a purchase history of a corresponding user. For example, a first account profile of the first user 102a may be indicative of the first purchase history. The issuer server 106 may credit and debit the payment accounts or the digital wallets based on purchases made by the users 102 from their corresponding payment accounts or digital wallets. Examples of the issuer server 106 may include, but are not limited to, computers, laptops, mini-computers, mainframe computers, any non-transient and tangible machines that can execute a machine-readable code, cloud-based servers, distributed server networks, a network of computer systems, or a combination thereof.

The first through third merchant servers 108a-108c are computing servers that are operated by first through third merchants, respectively. The first through third merchants are retailers that offer various products for sale. In one embodiment, each of the merchant servers 108 may be an independent entity offering products for sale. In another embodiment, each of the merchant servers 108 may be a merchant aggregator that offers, for sale, various products offered by a group of merchants. Each of the merchant servers 108 (e.g., the first merchant server 108a) may host a website or a service application that allows the corresponding merchant to offer the corresponding products for sale. In other words, the first through third merchant servers 108a-108c may be configured to list, on a corresponding website or service application, the offered products for sale. Examples of the merchant servers 108 may include, but are not limited to, computers, laptops, mini-computers, mainframe computers, any non-transient and tangible machines that can execute a machine-readable code, cloud-based servers, distributed server networks, a network of computer systems, or a combination thereof.

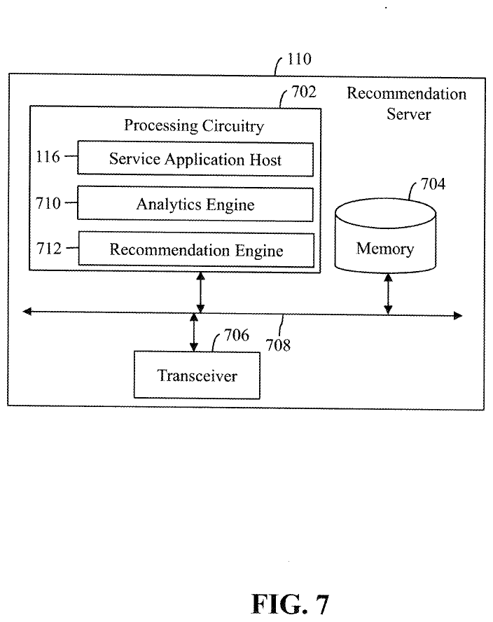

The recommendation server 110 includes suitable logic, circuitry, interface, and/or code, executable by the circuitry, that is configured to host the service application 114. The service application 114 may enable the users 102 to create their virtual accounts with the recommendation server 110, and add corresponding payment modes (e.g., the first payment mode) to their virtual accounts. The recommendation server 110 may be an apparatus, a system, or a server arrangement that is operated by an entity such as, but not limited to, an issuer (e.g., the first issuer), a payment network server (e.g., Mastercard), an e-commerce merchant, a brick-and-mortar merchant, a merchant aggregator, a consortium of merchants, or the like. The recommendation server 110 may be configured to offer the product recommendation service by hosting the service application 114. The product recommendation service offered by the recommendation server 110, is accessible to the users 102 by way of the service application 114 that runs on the user devices 104. The product recommendation service enables the recommendation server 110 to recommend one or more products to a sender (e.g., one of the users 102) that are suitable for presenting to a recipient (e.g., any one of the remaining users 102). The recommendation server 110 may include a service application host 116 that hosts the service application 114. Functionality of the service application host 116 is described in detail in FIG. 7.

The communication network 112 is a medium through which content and messages are transmitted between the first through third user devices 104a-104c, the issuer server 106, the merchant servers 108, and the recommendation server 110. Examples of the communication network 112 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 112 in accordance with various wired and wireless communication protocols, such as Transmission Control Protocol and Internet Protocol (TCP/IP), User Datagram Protocol (UDP), Long Term Evolution (LTE) communication protocols, or any combination thereof.

In operation, the first through third user devices 104a-104c may be utilized by the respective first through third users 102a-102c to access the service application 114. On accessing the service application 114, the first through third users 102a-102c may opt to register with the recommendation server 110. The recommendation server 110 may be configured to receive registration details of the first through third users 102a-102c from the respective first through third user devices 104a-104c. Based on the registration details, the recommendation server 110 may be configured to create the first virtual account of the first user 102a and second and third virtual accounts of the second and third users 102b and 102c, respectively. The recommendation server 110 may further register the first, second, and third payment modes of the first through third users 102a-102c, respectively, with the service application 114 and add the registered first, second, and third payment modes to the corresponding virtual accounts of the users 102.

The recommendation server 110 may further enable each registered user 102 to add other users to their respective gifting networks (for example, a family and friends' network). For example, the first user 102a may request the recommendation server 110 to add the second and third users 102b and 102c to a first gifting network of the first user 102a. The recommendation server 110 may link the first virtual account to the second and third virtual accounts based on a permission granted by the first user 102a, and add the second and third users 102b and 102c to the first gifting network. However, the recommendation server 110 may not add the first user 102a to second and third gifting networks of the respective second and third users 102b and 102c until the second and third users 102b and 102c grant permissions to the recommendation server 110 for adding the first user 102a to the second and third gifting networks. Based on the linking of the first virtual account to the second and third virtual accounts, the first purchase history associated with the first payment mode becomes accessible to the recommendation server 110. Thus, by utilizing the first purchase history, the recommendation server 110 may select one or more products to be recommended to the second and third users 102b and 102c for presenting to the first user 102a. However, if the first user 102a is not added to the second and third gifting networks, the second and third purchase histories associated with the respective second and third payment modes may not be accessible to the recommendation server 110 for selecting one or more products to be recommended to the first user 102a for presenting to the second and third users 102b and 102c, respectively.

The recommendation server 110 may be further configured to detect one or more events (e.g., a birthday, a wedding anniversary, a work anniversary, a calendar event, a product recommendation request, or the like) associated with a registered user, for example, the first user 102a. The detected events may require gifting one or more products to the first user 102a. Based on the detection of the events, the recommendation server 110 may be configured to recommend, to various users (for example, the second and third users 102b and 102c) who are added to the first gifting network of the first user 102a, one or more products suitable for presenting to the first user 102a.

For recommending the one or more products to the second user 102b for presenting to the first user 102a, the recommendation server 110 may be configured to utilize the first and second purchase histories associated with the registered first and second payment modes. The recommendation server 110 may determine a set of product categories that maps to the first purchase history. Following the determination of the set of product categories, the recommendation server 110 may generate a list of products that are associated with the determined set of product categories. The recommendation server 110 may filter the generated list based on a set of rules, to obtain a filtered list that includes the one or more products that may be recommended to the second user 102b for presenting to the first user 102a. One of the set of rules may pertain to the exclusion of various products that are already purchased by the first user 102a, from the generated list. The recommendation server 110 may be configured to render a user interface (UI) on the second user device 104b for displaying the filtered list to the second user 102b. The UI may enable the second user 102b to select a suitable product from the displayed one or more products for presenting to the first user 102a.

A person of ordinary skill in the art will appreciate that the scope of the disclosure is not limited to realizing the recommendation server 110 as stand-alone entity (as shown in FIG. 1). In another embodiment, the functionalities of the recommendation server 110 may be integrated into the issuer server 106, any of the merchant servers 108, a third-party merchant aggregator, or the like, without departing from the scope of the disclosure.

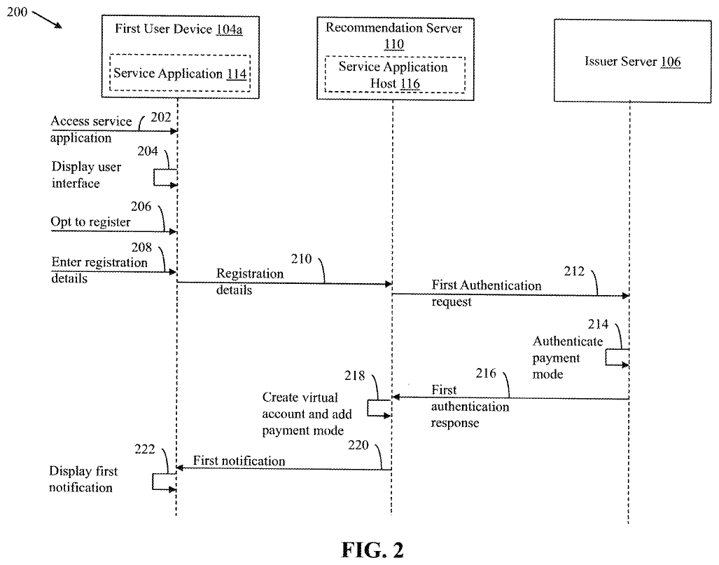

FIG. 2 represents a process flow diagram 200 that illustrates an exemplary scenario for registering a user with the recommendation server 110, in accordance with an exemplary embodiment of the present disclosure. For the sake of brevity, the registration process is described with respect to the first user 102a. The process flow diagram 200 involves the first user device 104a, the issuer server 106, and the recommendation server 110.

The first user device 104a may be utilized by the first user 102a to access the service application 114 that runs or is executed on the first user device 104a (as shown by arrow 202). A first UI of the service application 114 may be rendered on a display of the first user device 104a (as shown by arrow 204). The first UI may display a sign-up option and a login option. The sign-up option may allow the first user 102a to register with the service application 114 for accessing various services offered by the recommendation server 110. The login option may allow a registered user to access the service application 114 and avail various services (e.g., the product recommendation service) offered by the recommendation server 110. The sign-up option may be selected by the first user 102a if the first user 102a is a first-time user of the service application 114. The login option may be selected by the first user 102a if the first user 102a is a registered user of the service application 114. When the first user 102a is a registered user of the service application 114, the first user 102a may log into the service application 114 using a username and a password assigned to the first user 102a.

In a non-limiting example, it is assumed that the first user 102a is a first-time user of the service application 114, and opts to register with the recommendation server 110 by selecting the sign-up option (as shown by arrow 206). Based on the selection of the sign-up option by the first user 102a, the service application 114 may prompt, by way of the first UI, the first user 102a to enter registration details. Registration details of the first user 102a may include personal information of the first user 102a and details of the first payment mode. Personal information of the first user 102a may include a username, a password, a name of the first user 102a, an address, a birthdate, a marital status, a work status, contact details (e.g., an email address or a phone number), or the like. Details of the first payment mode (i.e., the first transaction card) may include a first transaction card number of the first transaction card, a first card verification value (CVV), a first personal identification number (PIN), an expiry date, a name on the first transaction card, or the like. The first user 102a may enter the registration details (i.e., the personal information and the details of the first payment mode) through the first UI (as shown by arrow 208).

The first user device 104a may communicate the registration details of the first user 102a to the recommendation server 110 over the communication network 112 (as shown by arrow 210). Based on the received registration details, the recommendation server 110 may communicate a first authentication request to the issuer server 106 (as shown by arrow 212) for authenticating the details of the first payment mode entered by the first user 102a. The first authentication request may be indicative of the details of the first payment mode. Based on the authentication request, the issuer server 106 may authenticate the first payment mode (as shown by arrow 214). Methods of authenticating the first payment mode will be known to those of skill in the art.

Based on the authentication, the issuer server 106 may communicate a first authentication response to the recommendation server 110 (as shown by arrow 216). The first authentication response may indicate whether the first payment mode is successfully authenticated. If the authentication response indicates that the authentication of the first payment mode is unsuccessful, the recommendation server 110 may communicate a notification to the first user device 104a, indicating an authentication failure and requesting the first user 102a to re-enter the details of the first payment mode. In a non-limiting example, it is assumed that the first payment mode is successfully authenticated. Based on the first authentication response, the recommendation server 110 may create the first virtual account for the first user 102a and register and add the first payment mode to the first virtual account (as shown by arrow 218). Registration of the first payment mode with the service application 114 corresponds to storing of the details of the first payment mode in a memory of the recommendation server 110. The details of the first payment mode may be stored in an encrypted format to ensure data security and integrity. Based on the creation of the first virtual account, the recommendation server 110 may communicate a first notification to the first user device 104a. The first notification may be indicative of the successful creation of the first virtual account (as shown by arrow 220). The first notification may be displayed, by the service application 114, to the first user 102a through the first UI (as shown by arrow 222).

It will be apparent to those of skill in the art that the second and third users 102b and 102c may be registered with the recommendation server 110 in a similar manner as described for the first user 102a. The recommendation server 110 may create the second and third virtual accounts for the second and third users 102b and 102c, respectively. The second and third payment modes of the second and third users 102b and 102c may be added to the second and third virtual accounts, respectively. The first through third users 102a-102c may use the respective first through third virtual accounts to access the service application 114. Further, the recommendation server 110 is configured to allow each user 102 to register more than one payment mode without deviating from the scope of the disclosure.

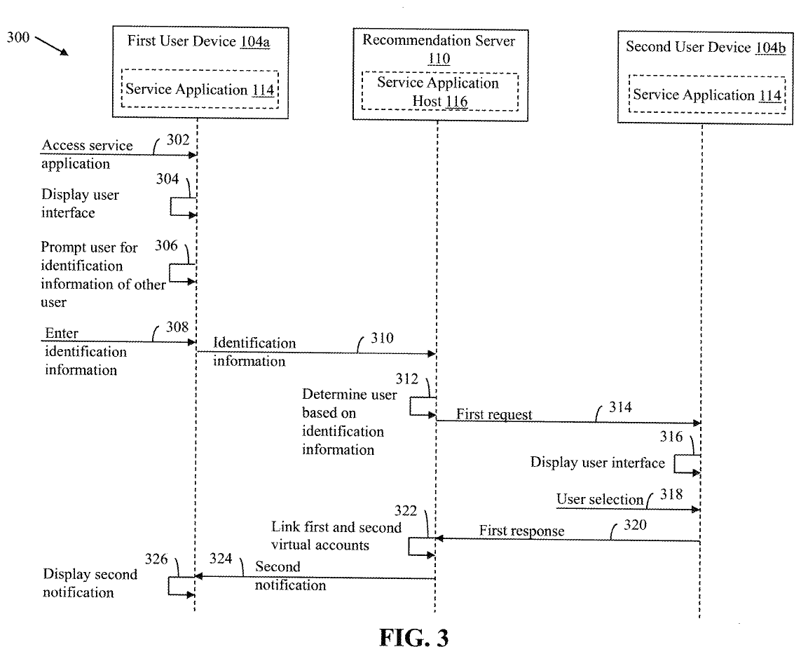

FIG. 3 represents a process flow diagram 300 that illustrates an exemplary scenario for linking virtual accounts of registered users, in accordance with an exemplary embodiment of the present disclosure. The process flow diagram 300 involves the first user device 104a, the second user device 104b, and the recommendation server 110. The recommendation server 110 may allow a registered user to add other registered users to a gifting network of the user. For example, the recommendation server 110 may allow the first user 102a to add the second and third users 102b and 102c to the first gifting network of the first user 102a. The first gifting network of the first user 102a is associated with the first payment mode of the first user 102a that is added to the first virtual account. In one embodiment, if multiple payment modes are added to the first virtual account, each added payment mode may be associated with a unique gifting network. In another embodiment, all the payment modes that are added to the first virtual account may be associated with a common gifting network of the first user 102a.

For adding the second user 102b to the first gifting network, the first user 102a may log into the service application 114 (i.e., access the service application 114) that runs or is executed on the first user device 104a by using the corresponding username and password (as shown by arrow 302). The first UI of the service application 114 may be rendered on the display of the first user device 104a (as shown by arrow 304). The recommendation server 110 may render the first UI on the display of the first user device 104a. By way of the first UI, first and second options may be presented to the first user 102a. The first option may allow the first user 102a to add one or more users to the first gifting network and the second option may allow the first user 102a to join a gifting network of another user. In a non-limiting example, it is assumed that the first user 102a selects the first option.

On the selection of the first option, the first user 102a may be prompted by the service application 114, being executed on the first user device 104a, to enter identification information of the other user that the first user 102a wants to add to the first gifting network (as shown by arrow 306). For adding the second user 102b to the first gifting network, the first user 102a may enter identification information of the second user 102b (as shown by arrow 308). Identification information of the second user 102b may include, but is not limited to, an email address of the second user 102b, a phone number of the second user 102b, and/or the like. The first user device 104a may communicate, to the recommendation server 110, the identification information of the second user 102b and the selection of the first option by the first user 102a (as shown by arrow 310). The selection of the first option by the first user 102a may indicate a permission granted by the first user 102a to link the first virtual account of the first user 102a to the second virtual account of the second user 102b.

Based on the identification information, the recommendation server 110 may determine whether the second user 102b is registered with the recommendation server 110 (as shown by arrow 312). In one embodiment, the second user 102b may not be registered with the recommendation server 110. In such a scenario, the recommendation server 110 may communicate, based on the received identification information of the second user 102b, a notification to the second user 102b, prompting the second user 102b to register with the recommendation server 110. For example, if the first user 102a had entered the phone number of the second user 102b as identification information, the recommendation server 110 may communicate a text message to the second user 102b using the phone number, prompting the second user 102b to register with the recommendation server 110. For the sake of brevity, it is assumed that the second user 102b is registered with the recommendation server 110.

When the second user 102b is registered with the recommendation server 110, the recommendation server 110 may communicate a first request to the second user device 104b, based on the identification information of the second user 102b (as shown by arrow 314). The first request may indicate an interest of the first user 102a in adding the second user 102b to the first gifting network. In other words, the first request may be an invite, to the second user 102b, to join the first gifting network of the first user 102a. When the second user device 104b receives the first request, the first UI may be rendered on the second user device 104b (as shown by arrow 316). The recommendation server 110 may render the first UI on a display of the second user device 104b. The first UI may present, to the second user 102b, a message indicating that the first user 102a wants to add the second user 102b to the first gifting network. The message may constitute an invitation, to the second user 102b, to join the first gifting network. The first UI may further present third and fourth options that enable the second user 102b to accept or decline the invite, respectively. If the second user 102b selects the fourth option, the recommendation server 110 may communicate a message to the first user device 104a, indicating that the second user 102b has declined the invite. In a non-limiting example, it is assumed that the second user 102b selects the third option and accepts the invite (as shown by arrow 318). In other words, the second user 102b accepts the invite to join the first gifting network. Based on the selection of the third option by the second user 102b, the second user device 104b may communicate a first response to the recommendation server 110 (as shown by arrow 320).

The first response may be indicative of the selection of the third option by the second user 102b. Based on the first response, the recommendation server 110 may link the first and second virtual accounts (as shown by arrow 322). In other words, the second user 102b is added to the first gifting network. The recommendation server 110 may communicate a second notification to the first user 102a, to indicate the linking of the first and second virtual accounts (as shown by arrow 324). In other words, the second notification may indicate the addition of the second user 102b to the first gifting network. Based on the second notification, the first UI rendered on the first user device 104a may display, to the first user 102a, a message indicative of the second notification (as shown by arrow 326).

Likewise, the recommendation server 110 may further add the third user 102c to the first gifting network based on the permission granted by the first user 102a. Based on the linking of the first virtual account to the second and third virtual accounts, the first purchase history of the first user 102a may be available to the recommendation server 110 for recommending one or more products to the second and third users 102b and 102c for presenting to the first user 102a.

For the recommendation server 110 to recommend products to a registered user for presenting to another user, the registered user must be added to a gifting network of the other registered user. For example, the recommendation server 110 may recommend products to the second user 102b for presenting to the first user 102a, only if the second user 102b is added to the first gifting network. The recommendation server 110 may not recommend products to the first user 102a, for presenting to the second user 102b, unless the first user 102a is added to the second gifting network of the second user 102b.

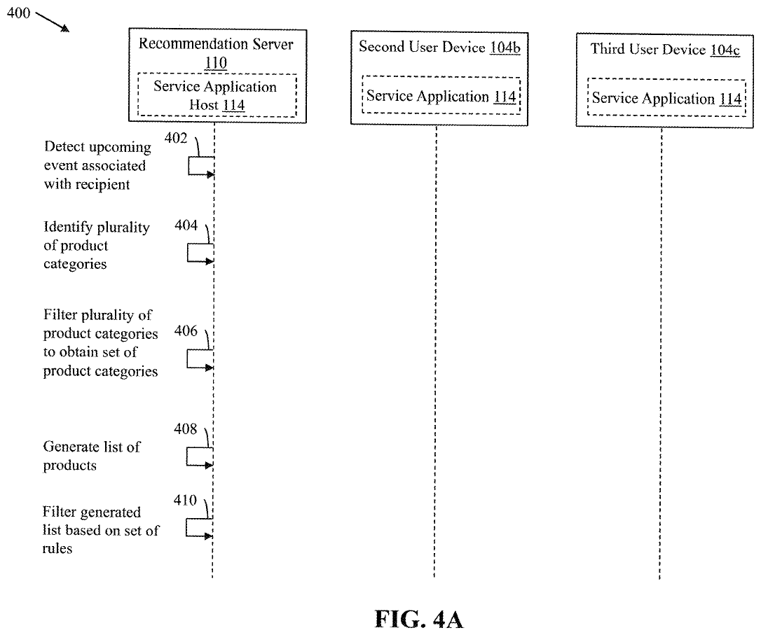

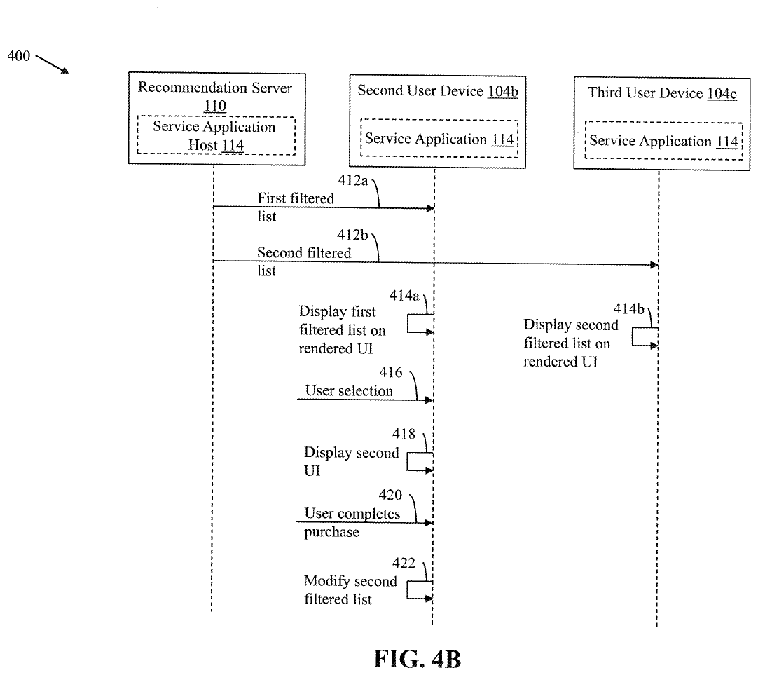

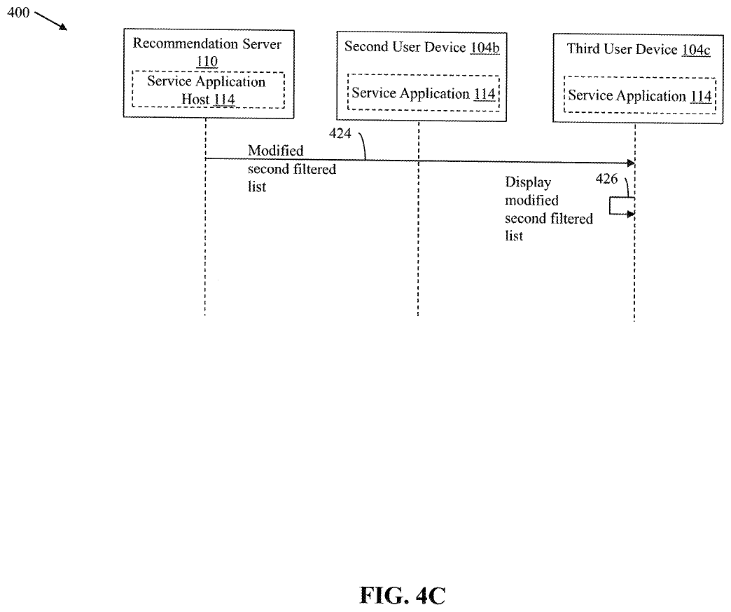

FIGS. 4A-4C, collectively, represent a process flow diagram 400 that illustrates an exemplary scenario for recommending products to one or more senders for presenting to a recipient, in accordance with an exemplary embodiment of the present disclosure. The process flow diagram 400 includes the first through third user devices 104a-104c, the first merchant server 108a, and the recommendation server 110. For the sake of ongoing description, the first user 102a is interchangeably referred to as “the recipient 102a” and the second and third users 102b and 102c are interchangeably referred to as “the first sender 102b” and “the second sender 102c”, respectively.

The recommendation server 110 may be configured to detect an upcoming event associated with the recipient 102a (as shown by arrow 402). In one embodiment, the upcoming event may be a birthday of the recipient 102a, a wedding anniversary of the recipient 102a, a work anniversary of the recipient 102a, or the like. In another embodiment, the upcoming event may be a calendar event created by at least one of the first and second senders 102b and 102c for the recipient 102a. In another embodiment, the upcoming event may be a product recommendation request initiated by at least one of the first and second senders 102b and 102c for the recipient 102a. The first and second senders 102b and 102c may initiate the product recommendation request by accessing the service application 114 that runs on their respective user devices 104b and 104c. The recommendation server 110 may be configured to detect the upcoming event based on the personal information entered by the recipient 102a during registration. In one embodiment, the recommendation server 110 may be further configured to access, with the permission of the recipient 102a, a social media profile of the recipient 102a for detecting the upcoming event. The upcoming event may require presenting of products to the recipient 102a by the first and second senders 102b and 102c. In other words, the upcoming event may warrant gifting of products to the first user 102a. Thus, the recommendation server 110 may provide various product recommendations to various users that are included in the first gifting network of the recipient 102a. Since there are two users (i.e., the first and second senders 102b and 102c) in the first gifting network of the recipient 102a, the recommendation server 110 may be required to provide product recommendations to the first and second senders 102b and 102c.

For providing the product recommendations, the recommendation server 110 may access the first purchase history of the recipient 102a and identify a plurality of product categories associated with the first purchase history (as shown by arrow 404). The first purchase history may be indicative of a plurality of products purchased by the recipient 102a in the past, and each identified product category may correspond to at least one product included in the first purchase history. For example, if the first purchase history is indicative of a purchase of a smartphone by the recipient 102a, the recommendation server 110 may identify ‘consumer electronics’ as a corresponding product category.

The recommendation server 110 may then filter the plurality of product categories to obtain a set of product categories (as shown by arrow 406). The recommendation server 110 may filter the identified plurality of product categories based on a frequency of purchase by the recipient 102a with respect to each of the plurality of product categories. For filtering the plurality of product categories, the recommendation server 110 may exclude one or more product categories for which the frequency of purchase is greater than a first threshold or less than a second threshold. The first and second thresholds may be set by the recommendation server 110 based on an average purchase behavior. The average purchase behavior may be determined by the recommendation server 110 by analyzing purchase histories of multiple users. Consequently, product categories associated with products that are bought too frequently (i.e., the frequency of purchase is higher than the first threshold) or too rarely (i.e., the frequency of purchase is less than the second threshold) may be excluded from the identified plurality of product categories. For example, groceries or medicines may be excluded from the identified plurality of product categories, since groceries and medicines are associated with a frequency of purchase that is higher than the first threshold. In another example, automobiles may be excluded from the identified plurality of product categories, since automobiles are associated with a frequency of purchase that is lower than the second threshold. Since the determined set of product categories is a subset of the plurality of product categories, the determined set of product categories also maps to the first purchase history of the recipient 102a.

The recommendation server 110 may then generate a list of products that are associated with the determined set of product categories (as shown by arrow 408). The generated list may include products associated with each product category in the set of product categories. For example, if one of the set of product categories is apparel, the generated list may include, among others products, one or more apparel products. The products included in the generated list may be further determined based on purchase histories of other registered users that are similar to the first purchase history of the recipient 102a. For example, the recommendation server 110 may determine that product categories associated with a purchase history of a fourth registered user (not shown) are similar to the determined set of product categories. Based on the similarity, the recommendation server 110 may include, in the generated list, products purchased by the fourth registered user. The recommendation server 110 may use various algorithms pertaining to machine learning, deep learning, or the like to determine the products to be included in the generated list. The recommendation server 110 may be configured to filter the generated list based on a set of rules (as shown by arrow 410). Based on the filtration of the generated list, the recommendation server 110 may obtain first and second filtered lists. Each of the first and second filtered lists may include one or more products that are to be recommended to the first and second senders 102b and 102c, respectively, for presenting to the recipient 102a. The set of rules may be stored in the memory of the recommendation server 110.

A first rule may pertain to exclusion of those products, from the generated list, that are already purchased by the recipient 102a to obtain the first and second filtered lists. In other words, the first and second filtered lists are exclusive of the products that are already purchased by the recipient 102a. For example, the recipient 102a may have bought a digital camera by using the first payment mode. Thus, all types of digital cameras may be excluded from the generated list to obtain the first and second filtered lists.

A second rule may pertain to excluding products from the generated list based on a purchase history of a sender (e.g., the first and second senders 102b and 102c), to obtain the first and second filtered lists. In one embodiment, the recommendation server 110 may determine a first spending capacity of the first sender 102b based on the second purchase history. The determination of the first spending capacity of the first sender 102b may be based on various factors such as, but not limited to, an income of the first sender 102b, a monthly expenditure of the first sender 102b, a price of each product purchased by the first sender 102b for presenting to other recipients, or the like. In another embodiment, the first spending capacity may be explicitly specified by the first sender 102b. Based on the various factors, the recommendation server 110 may determine the first spending capacity (e.g., ‘$50’) of the first sender 102b. The recommendation server 110 may exclude those products from the generated list whose price exceeds ‘$50’, to obtain the first filtered list. Similarly, to obtain the second filtered list, the recommendation server 110 may determine a second spending capacity of the second sender 102b and exclude those products from the generated list whose price exceeds the second spending capacity. Thus, the first and second filtered lists are exclusive of products, whose prices exceed the first and second spending capacities, respectively.

A third rule may pertain to inclusion of products in the first and second filtered lists based on merchant preferences of the recipient 102a, the first sender 102b, or the second sender 102c. For obtaining the first filtered list, the recommendation server 110 may determine the merchant preferences of the recipient 102a and the first sender 102b based on the first and second purchase histories, respectively. The recommendation server 110 may assess the first and second purchase histories to determine a frequency of purchases by the recipient 102a and the first sender 102b with respect to each merchant associated with the products included in the generated list. For example, the recommendation server 110 may determine that the recipient 102a and the first sender 102b prefer to only shop at BestBuy® or Amazon® for electronic products. As a consequence, the first filtered list may only include those electronics products that are available at ‘BestBuy’ or ‘Amazon’. In another example, the recommendation server 110 may determine, based on the second purchase history, that the second user 102b is in possession of one or more gift coupons or discount coupons that may be redeemable at the first merchant. Consequently, the first filtered list may include various products that are offered for sale by the first merchant. Thus, the products, in the generated list, that conform to the determined merchant preferences of the recipient 102a and the first sender 102b are included in the first filtered list. Likewise, the products, in the generated list, that conform to the determined merchant preferences of the recipient 102a and the second sender 102c are included in the second filtered list.

A fourth rule may pertain to exclusion of those products from the generated list that have a low relevancy in regards to a geographic location of the recipient 102a. Thus, the first and second filtered lists may be exclusive of those products that have a low relevancy in regards to the geographic location of the recipient 102a. In one embodiment, the recommendation server 110 may identify the geographic location of the recipient 102a based on the personal information entered by the recipient 102a at the time of registration or the first purchase history of the recipient 102a. In another embodiment, the recommendation server 110 may receive the geographic location of the recipient 102a from the first user device 104a. The recommendation server 110 may then determine a relevancy score for each product, included in the generated list, in regards to the geographic location of the recipient 102a. For example, in one embodiment, the recommendation server 110 may determine that the recipient 102a lives in Dubai. The recommendation server 110 may then determine a relevancy score for each apparel product included in the generated list. Consequently, the recommendation server 110 may determine that a relevancy score of some apparel products, corresponding to a certain product category (e.g., winter wear), included in the generated list is less than a third threshold set by the recommendation server 110. Thus, the first and second filtered lists may be exclusive of products having the relevancy scores below the third threshold. Products associated with product categories such as, but not limited to, ‘consumer electronics’, ‘sports gear’, or the like, may be independent of the geographic location. So, relevancy scores may not be applicable for the products associated with such product categories.

A fifth rule may pertain to inclusion of those products, in the first and second filtered lists, that constitute a virtual wishlist of the recipient 102a. The recipient 102a may maintain a virtual wishlist on the service application 114 to indicate various products that are preferred by the recipient 102a. In another embodiment, the virtual wishlist may be maintained by the recipient 102a on a merchant website of a merchant (e.g., the first merchant) associated with the recommendation server 110. The virtual wishlist may be accessed by the recommendation server 110 based on a permission granted by the recipient 102a. In another embodiment, the recommendation server 110 may construct the virtual wishlist based on one or more products, pages, or groups followed, liked, or shared by the recipient 102a on one or more social networks.

It will be apparent to those of skill in the art that the first through fifth rules described above are merely exemplary and that the set of rules may include other rules without deviating from the scope of the disclosure. For example, the set of rules may further include one or more other rules pertaining to inclusion or exclusion of products based on miscellaneous factors such as, but not limited to, an age of the recipient 102a, a gender of the recipient 102a, a travel profile of the recipient 102a, recent fashion trends, changes in shopping patterns of the recipient 102a, or the like. Further, the first and second filtered lists may be exclusive of those products that are already presented to the recipient 102a by any other sender. The recommendation server 110 may filter the generated list based on a combination of various rules included in the set of rules, to obtain the one or more products for recommending to each of the first and second senders 102b and 102c.

The recommendation server 110 may be further configured to rank the one or more products included in each of the first and second filtered lists based on affinity of the recipient 102a towards each product included in the first and second filtered lists. The affinity of the recipient 102a towards each product may be determined based on the first purchase history of the recipient 102a. For example, for each product included in the first and second filtered lists, the recommendation server 110 may determine a correlation between a product category associated with the product and a frequency of purchase by the recipient 102a in regards to products associated with the product category. A higher frequency of purchase may correspond to a higher affinity.

The recommendation server 110 may be configured to communicate messages indicative of the first and second filtered lists to the second and third user devices 104b and 104c, respectively (as shown by arrows 412a and 412b). Based on the messages, the recommendation server 110 may render the first UI on the second and third user devices 104b and 104c, by way of the executed service application 114, to display the first and second filtered lists, respectively (as shown by arrows 414a and 414b). The one or more products in each of the first and second filtered lists may be displayed as per the ranking and are selectable by the first and second senders 102b and 102c, respectively. Each displayed product may constitute a recommendation, by the recommendation server 110, to the first and second senders 102b and 102c for purchasing and presenting to the recipient 102a. The first and second filtered lists may include different products as the second and third purchase histories of the first and second senders 102b and 102c may be different. In other words, the one or more products recommended to the first sender 102b, for presenting to the recipient 102a, may be different from the one or more products recommended to the second sender 102c, for presenting to the recipient 102a.

The first sender 102b may select a first product included in the displayed first filtered list, for purchasing and presenting to the recipient 102a (as shown by arrow 416). Based on the selection by the first sender 102b, the recommendation server 110 may allow the first sender 102b to purchase the first product. In one embodiment, the recommendation server 110 may further host an e-commerce platform, and the first product selected by the first sender 102b may be offered for sale by the e-commerce platform of the recommendation server 110. In such a scenario, the recommendation server 110 may redirect the control from the first UI to a second UI of the e-commerce platform, and the second UI is rendered on the display of the second user device 104b (as shown by arrow 418). In other words, the recommendation server 110 renders the second UI on the display of the second user device 104b by way of the service application 114. The second UI may be associated with a payment gateway. The first sender 102b may purchase the selected first product by using the second payment mode added to the second virtual account (as shown by arrow 420).

In one exemplary scenario, the first product may be included in both the first and second filtered lists. Consequently, the recommendation server 110 may modify, in real time, the second filtered list to exclude the first product (as shown by arrow 422). In other words, the recommendation server 110 may remove, from an already displayed filtered list (e.g., the modified second filtered list), products (e.g., the first product) that are gifted to the recipient 102a. The recommendation server 110 may communicate another message indicative of the modified second filtered list to the third user device 104c (as shown by arrow 424). Based on the message, the modified second filtered list may be displayed on the first UI rendered on the third user device 104c (as shown by arrow 426). The second sender 102c may purchase a second product, included in the modified second filtered list, in a manner similar to the purchase of the first product. Based on the purchase of the first and second products, the first and second products may be presented (i.e., delivered) to the recipient 102a on or before a date corresponding to the detected upcoming event.

In another embodiment, the recommendation server 110 may redirect the control from the first UI to a third UI of a merchant application (not shown) of the first merchant when the first sender 102b selects the first product that is offered for sale by the first merchant. The first merchant application may be hosted by the first merchant server 108a and may be accessible by the first sender 102b by way of the second user device 104b. The first merchant application may enable the first sender 102b to complete the purchase of the first product, for presenting to the recipient 102a. The first sender 102b may complete the purchase of the first product by way of the second payment mode or any other payment mode of the second sender 102b. Based on the purchase of the first product, the first merchant server 108a may communicate, to the recommendation server 110, a message indicative of the completion of the purchase, of the first product, by the first sender 102b. Based on the message, the recommendation server 110 may communicate, to the first merchant server 108a, a message indicative of an address for the delivery of the first product. The first product may be delivered to the address of the recipient 102a or the address of the first sender 102b.

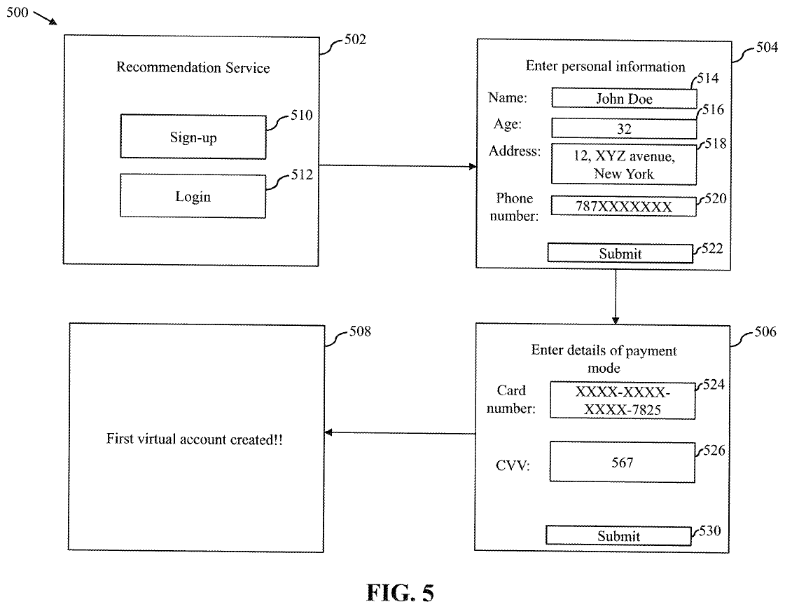

FIG. 5 represents an exemplary scenario 500 that illustrates UI screens 502-508 of the service application 114, in accordance with an exemplary embodiment of the present disclosure. The UI screens 502-508 are rendered on a display (not shown) of the first user device 104a. FIG. 5 has been explained in conjunction with FIG. 2.

When the first user device 104a is utilized by the recipient 102a to access the service application 114, the UI screen 502 may be rendered on the display of the first user device 104a by the recommendation server 110. The UI screen 502 may include the sign-up and login options 510 and 512, respectively. The sign-up option 510 may allow the recipient 102a to register with the recommendation server 110 when the first user 102a is a first-time user of the service application 114. The login option 512 may allow the recipient 102a to log into the service application 114 if the first user 102a is a pre-existing user of the service application 114. As described in the foregoing in FIG. 2, the recipient 102a may select the sign-up option 510. When the recipient 102a selects the sign-up option 510, the UI screen 504 may be rendered on the display of the first user device 104a.

The UI screen 504 may present a message, requesting the recipient 102a to enter the personal information of the recipient 102a. The UI screen 504 may include first through fourth text boxes 514-520 that allow the recipient 102a to enter the name (i.e., ‘John Doe’), the age (i.e., ‘32’), the address (i.e., ‘12, XYZ Avenue, New York’), the phone number (i.e., ‘787XXXXXXX’), respectively. The UI screen 504 may include additional text boxes (not shown) that allow the recipient 102a to enter additional personal information such as the email address of the recipient 102a, the birthdate of the recipient 102a, or the like. When the first user 102a selects a first submit button 522, the UI screen 506 may be rendered on the display of the first user device 104a.

The UI screen 506 may present a message requesting the first user 102a to add a payment mode (i.e., enter details of a payment mode). The UI screen 506 may include fifth and sixth text boxes 524 and 526 that allow the first user 102a to enter the first transaction card number (i.e., ‘XXXX-XXXX-XXXX-7825’) of the first transaction card and the first CVV (i.e., ‘567’). It will be apparent to those of skill in the art that the recipient 102a may be required to enter additional information such as a name of cardholder, the expiry date of the first transaction card, or the like. The UI screen 506 may further include a second submit button 530. When the first user 102a selects the second submit button 530, the first user device 104a may communicate the registration details (i.e., the personal information of the recipient 102a and the details of the first payment mode) to the recommendation server 110. As described in the foregoing description of FIG. 2, the recommendation server 110 may create the first virtual account based on the personal information of the recipient 102a. The recommendation server 110 may add the first payment mode to the first virtual account. On creation of the first virtual account, the recommendation server 110 may communicate the first notification to the first user device 104a. Based on the first notification, the UI screen 508 may be rendered on the display of the first user device 104a. The UI screen 508 displays a message indicating that the first virtual account is successfully created and the recipient 102a is registered with the recommendation server 110.

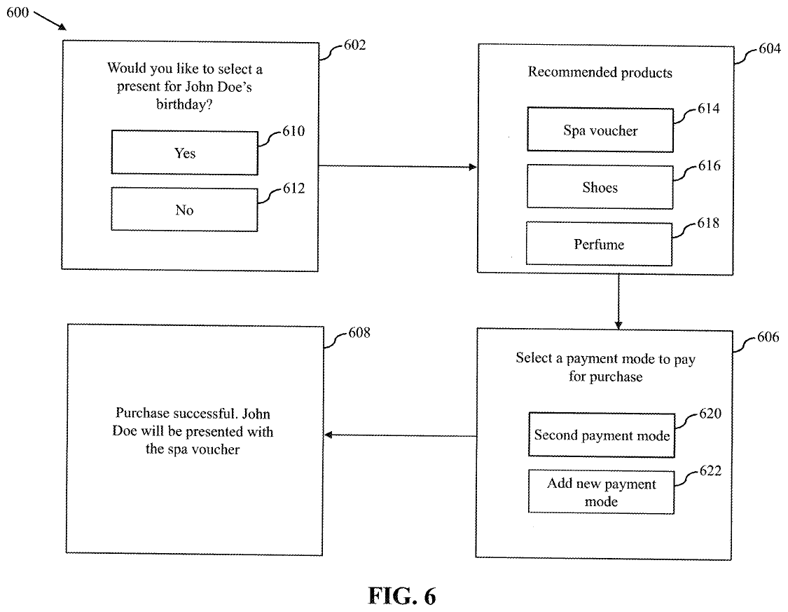

FIG. 6 represents an exemplary scenario 600 that illustrates UI screens 602-608 of the service application 114, in accordance with another exemplary embodiment of the present disclosure. The UI screens 602-608 are rendered on a display (not shown) of the second user device 104b. FIG. 6 has been explained in conjunction with FIGS. 4A-4C.

The UI screen 602 may be rendered on the display of the second user device 104b that executes the service application 114. The UI screen 602 may present a message asking the first sender 102b if the first sender 102b would like to purchase a product to present to the recipient 102a for the detected upcoming event (for example, the birthday of the recipient 102a). The UI screen 602 may include first and second user-selectable options 610 and 612, respectively. A selection of the first user-selectable option 610 may indicate an interest of the first sender 102b in purchasing a product for the detected upcoming event. A selection of the second user-selectable option 612 may indicate that the first sender 102b is not interested in purchasing any product for the detected upcoming event. In an exemplary scenario, the first sender 102b may select the first user-selectable option 610. When the first sender 102b selects the first user-selectable option 610, the UI screen 604 may be rendered on the display of the second user device 104b.

The UI screen 604 may display the first filtered list including one or more products. The one or more products may be recommended by the recommendation server 110 to the first sender 102b for presenting to the recipient 102a for the detected upcoming event. The UI screen 604 presents third through fifth user-selectable options 614-618. Each of the third through fifth user-selectable options 614-618 is indicative of a product (i.e., ‘Spa voucher’, ‘Shoes’, and ‘Perfume’) included in the first filtered list. For the sake of simplicity, the first filtered list is shown to include only three products. It will be apparent to those of skill in the art that the first filtered list may include any number of products without deviating from the scope of the disclosure. In one embodiment, the UI screen 604 may further display various product details (for example, a price, previous user reviews, a merchant, a delivery time, and/or the like) of the one or more products included in the first filtered list. The first sender 102b may select any of the third through fifth user-selectable options 614-618. In one exemplary scenario, the first sender 102b may select the third user-selectable option 614 for presenting the ‘Spa voucher’ to the recipient 102a. When the first sender 102b selects the third user-selectable option 614, the UI screen 606 may be rendered on the display of the second user device 104b.

The UI screen 606 may present sixth and seventh user-selectable options 620 and 622 for purchasing the ‘spa voucher’. The sixth user-selectable option 620 may allow the first sender 102b to purchase the ‘spa voucher’ using the second payment mode added to the second virtual account. The seventh user-selectable option 622 may allow the first sender 102b to purchase the ‘spa voucher’ using a payment mode other than the second payment mode. On completion of the purchase, the UI screen 608, indicating a successful purchase of the ‘spa voucher’ by the first sender 102b, may be rendered on the display of the second user device 104b.

FIG. 7 is a block diagram that illustrates the recommendation server 110, in accordance with an exemplary embodiment of the present disclosure. The recommendation server 110 may include processing circuitry 702, the memory (hereinafter, referred to and designated as ‘the memory 704’), and a transceiver 706. The processing circuitry 702, the memory 704, and the transceiver 706 may communicate with each other by way of a communication bus 708. The processing circuitry 702 may include the service application host 116, an analytics engine 710, and a recommendation engine 712.

The processing circuitry 702 includes suitable logic, circuitry, interfaces, and/or code, executed by the circuitry, to recommend products to senders (e.g., the first and second senders 102b and 102c) for presenting to a recipient (e.g., the recipient 102a). The processing circuitry 702 may be configured to store, in the memory 704, virtual accounts of various users (e.g., the recipient 102a and the first and second senders 102b and 102c) who are registered with the recommendation server 110. For example, the first virtual account of the recipient 102a, that includes the personal information of the recipient 102a and the details of the first payment mode, may be stored by the processing circuitry 702 in the memory 704. The processing circuitry 702 may be further configured to host the service application 114 that is executable on the first through third user devices 104a-104c. The processing circuitry 702 may be further configured to authenticate the recipient 102a, the first sender 102b, or the second sender 102c when the recipient 102a, the first sender 102b, or the second sender 102c attempt to log into the service application 114 by utilizing the respective first through third user devices 104a-104c.

Examples of the processing circuitry 702 may include, but are not limited to, an application-specific integrated circuit (ASIC) processor, a reduced instruction set computer (RISC) processor, a complex instruction set computer (CISC) processor, a field programmable gate array (FPGA), and the like. The processing circuitry 702 may execute various product recommendation operations by way of the service application host 116, the analytics engine 710, and the recommendation engine 712.

The service application host 116 may be configured to execute one or more operations for hosting the service application 114 that is executable on various user devices, such as the user devices 104. The service application host 116 may be configured to control the service application 114 and cause the service application 114 to perform various operations (such as the rendering of the UI screens 502-508 and 602-608) as described in FIG. 5. By way of the UI screens 502-508, the service application host 116 may be configured to allow users (such as the first through third users 102a-102c) to register with the recommendation server 110 for availing the product recommendation service. The service application host 116 may be further configured to allow a user (e.g., the recipient 102a) to invite other users (e.g., the first sender 102b) to join a gifting network (e.g., the first gifting network) of the user. By way of the UI screens 602-608, the service application host 116 may allow senders (e.g., the first and second senders 102b and 102c) to view and purchase one or more products recommended by the recommendation server 110 for presenting to a recipient (e.g., the recipient 102a).

The analytics engine 710 may be configured to detect upcoming events (e.g., the birthday of the recipient 102a) and analyze purchase histories (e.g., the first through third purchase histories) of various users (e.g., the recipient 102a and the first and second senders 102b and 102c). The analytics engine 710 may be further configured to generate the list of products and filter the generated list based on the set of rules. The analytics engine 710 may employ artificial intelligence to generate the list and filter the generated list to obtain the first and second filtered lists.

The recommendation engine 712 may be configured to facilitate recommendation of products included in filtered lists (such as the first and second filtered lists) to senders (e.g., the first and second senders 102b and 102c). The recommendation of the one or more products may be provided by way of the service application 114 that is executed on user devices (e.g., the second and third user devices 104b and 104c) of the senders. The recommendation engine 712 may be further configured to enable the senders to purchase the one or more products recommended by the recommendation engine 712. When the recommendation server 110 implements the e-commerce platform and offers the recommended one or more products for sale, the recommendation engine 712 may facilitate purchase of the one or more products from the e-commerce platform. In other embodiments, the recommendation engine 712 may redirect the senders to merchants (e.g., the first through third merchants) that offer the recommended one or more products for sale.

The memory 704 includes suitable logic, circuitry, interfaces, and/or code, executable by the circuitry, to store the virtual accounts of users (such as the recipient 102a) and details of payment modes (e.g., the first payment mode) associated with each user. The details of payment modes may be stored in an encrypted format to ensure data security and integrity. The memory 704 may be further configured to store details pertaining to various gifting network created by the service application host 116 for various registered users. Examples of the memory 704 may include a random-access memory (RAM), a read-only memory (ROM), a removable storage drive, a hard disk drive (HDD), a flash memory, a solid-state memory, and the like. It will be apparent to a person skilled in the art that the scope of the disclosure is not limited to realizing the memory 704 in the recommendation server 110, as described herein. In another embodiment, the memory 704 may be realized in form of a database server or a cloud storage working in conjunction with the recommendation server 110, without departing from the scope of the disclosure.

The transceiver 706 may include suitable logic, circuitry, interfaces, and/or code, executable by the circuitry, to transmit and receive data over the communication network 112 using one or more communication network protocols. The transceiver 706 may transmit various requests and messages to the first through third user devices 104a-104c, the issuer server 106, and the merchant servers 108. The transceiver 706 may further receive various requests and messages from the first through third user devices 104a-104c, the issuer server 106, and the merchant servers 108. Examples of the transceiver 706 may include, but are not limited to, an antenna, a radio frequency transceiver, a wireless transceiver, a Bluetooth transceiver, an ethernet port, a universal serial bus (USB) port, or any other device configured to transmit and receive data.

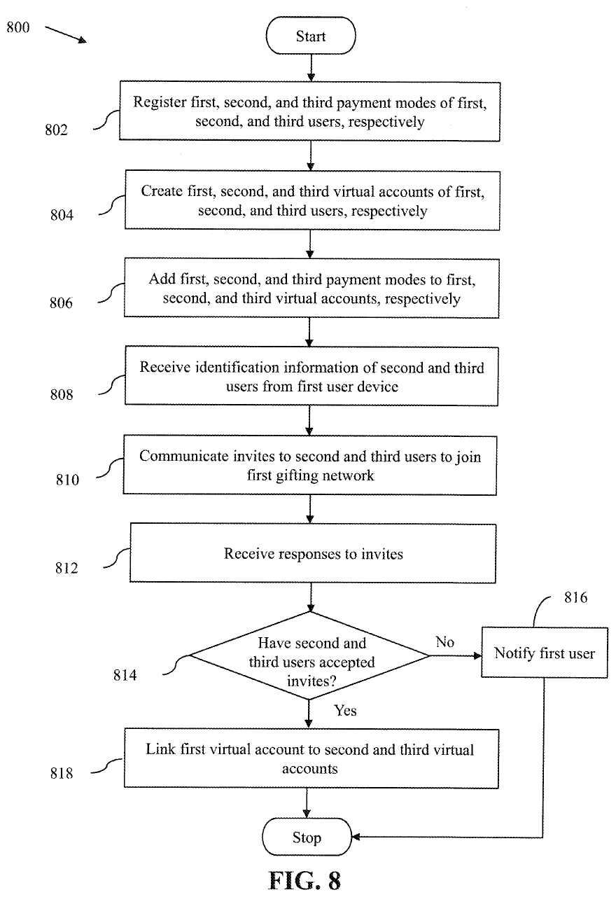

FIG. 8 is a flow chart 800 that illustrates a method for registering various users with the service application 114 hosted by the recommendation server 110, in accordance with an exemplary embodiment of the present disclosure. The flow chart 800 is described with respect to the first through third users 102a-102c.

At step 802, the recommendation server 110 registers the first through third payment modes of the first through third users 102a-102c, respectively, with the service application 114. At step 804, the recommendation server 110 creates the first through third virtual accounts of the first through third users 102a-102c, respectively, for allowing the first through third users 102a-102c to access the service application 114 on their respective user devices 104. At step 806, the recommendation server 110 further adds the first through third payment modes to the respective first through third virtual accounts based on the registration of the first through third payment modes. For adding the second and third users 102b and 102c to the first gifting network, the first user 102a may provide the identification information of the second user 102b and the identification information of the third user 102c to the recommendation server 110 by accessing the service application 114 that runs or is executed on the first user device 104a.

At step 808, the recommendation server 110 receives the identification information of the second and third users 102b and 102c from the first user device 104a (as described in the foregoing description of FIG. 3). At step 810, based on the received identification information, the recommendation server 110 communicates first and second requests (e.g., first and second invites) to the respective second and third user devices 104b and 104c, requesting the second and third users 102b and 102c to join the first gifting network. The second and third users 102b and 102c may accept or decline the first and second invites, respectively. At step 812, the recommendation server 110 receives first and second responses to the first and second invites from the second and third user devices 104b and 104c, respectively. Each response may indicate whether a corresponding user has accepted or declined a corresponding invite to join the first gifting network. At step 814, the recommendation server 110 determines whether the second and third users 102b and 102c have agreed to join the first gifting network, i.e., accepted the first and second invites, respectively. If at step 814, it is determined that any of the second and third users 102b and 102c have not accepted the corresponding invite, step 816 is performed. At step 816, the recommendation server 110 communicates a notification to the first user device 104a, notifying the first user 102a that at least one of the second and third users 102b and 102c have declined the corresponding invite. If at step 814, it is determined that the second and third users 102b and 102c have accepted the corresponding invites (i.e., the first and second invites), step 818 is performed. At step 818, the recommendation server 110 links the first virtual account to the second and third virtual accounts. In other words, the second and third users 102b and 102c are added to the first gifting network.

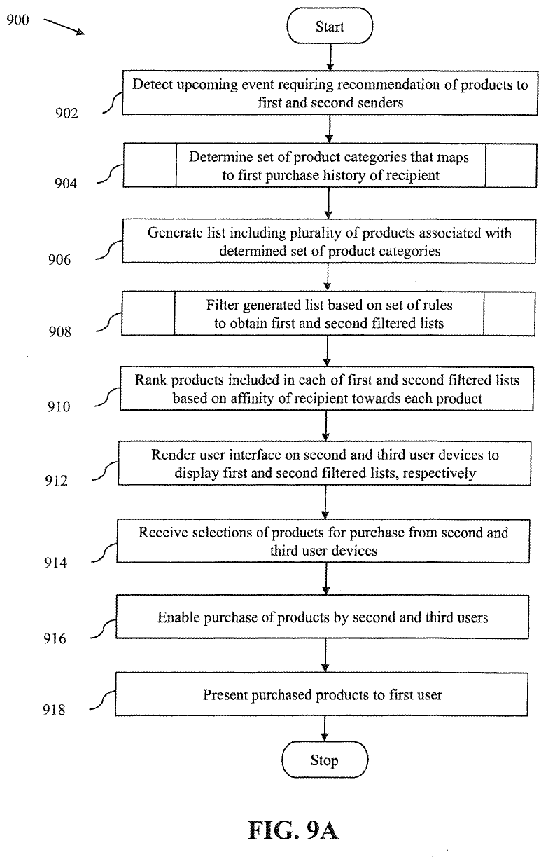

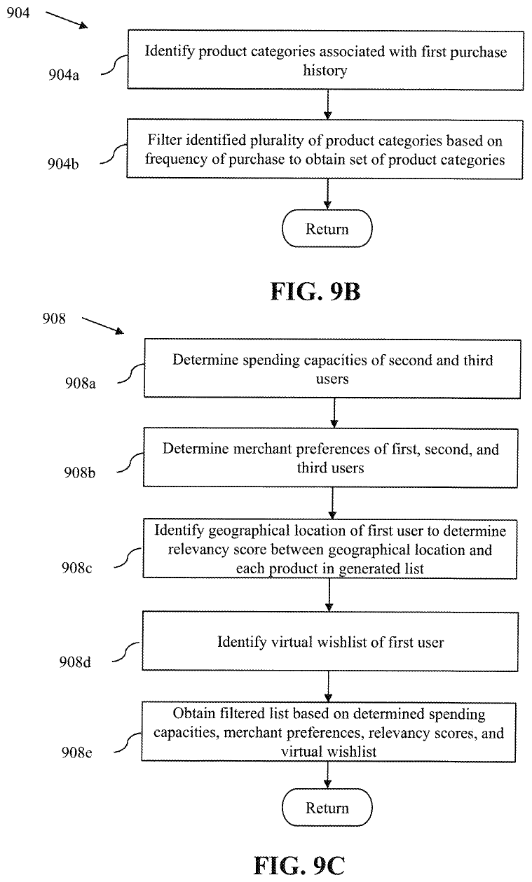

FIGS. 9A-9C, collectively represent a flow chart 900 that illustrates a method for recommending products to a sender for presenting to a recipient, in accordance with an exemplary embodiment of the present disclosure. The flow chart 900 is described with respect to the first user 102a (i.e., the recipient 102a) and the second and third users 102b and 102c (i.e., the first and second senders 102b and 102c). The second and third users 102b and 102c are added to the first gifting network of the first user 102a by the recommendation server 110.

With reference to FIG. 9A, at step 902, the recommendation server 110 detects an upcoming event associated with the recipient 102a (as described in the foregoing description of FIG. 4A). The detected upcoming event may require recommendation of one or more products to the first and second senders 102b and 102c, who are added to the first gifting network, for presenting to the recipient 102a. At step 904, the recommendation server 110 determines the set of product categories that maps to the first purchase history of the recipient 102a (as described in the foregoing description of FIG. 4A). The steps involved in the determination of the set of product categories are described in FIG. 9B.

Referring now to FIG. 9B, at step 904a, the recommendation server 110 identifies the plurality of product categories associated with the first purchase history of the recipient 102a (as described in the foregoing description of FIG. 4A). At step 904b, the recommendation server 110 filters the plurality of product categories to obtain the set of product categories. The filtration may be based on the frequency of purchase by the recipient 102a with respect to each product category in the first purchase history. Product categories associated with products that are purchased rarely (i.e., frequency of purchase is below the second threshold) or too frequently (i.e., frequency of purchase exceeds the first threshold) may be excluded from the plurality of product categories to obtain the set of product categories. The process returns to step 906 of FIG. 9A.

Referring back to FIG. 9A, at step 906, the recommendation server 110 generates a list including multiple products associated with the determined set of product categories. The list of products includes the products corresponding to each of the determined set of product categories. At step 908, the recommendation server 110 filters the generated list based on the set of rules to obtain filtered lists (e.g., the first and second filtered lists) including one or more recommended products for the first and second senders 102b and 102c (as described in the foregoing description of FIG. 4A). The set of rules is described in FIG. 9C.

Referring now to FIG. 9C, at step 908a, the recommendation server 110 determines the spending capacities of the first and second senders 102b and 102c based on the second and third purchase histories, respectively. At step, 908b, the recommendation server 110 determines the merchant preferences of the recipient 102a and the first and second senders 102b and 102c based on the respective first through third purchase histories. At step 908c, the recommendation server 110 identifies the geographical location of the recipient 102a for determining the relevancy score of the geographical location with respect to the products included in the generated list. At step 908d, the recommendation server 110 identifies the virtual wishlist of the recipient 102a. At step 908e, the recommendation server 110 obtains the first and second filtered lists based on the identified spending capacities of the first and second senders 102b and 102c, the identified merchant preferences of the recipient 102a and the first and second senders 102b and 102c, the determined relevancy scores, and the virtual wishlist. The process returns to step 910 of FIG. 9A.

Referring back to FIG. 9A, at step 910, the recommendation server 110 ranks the one or more products included in each of the first and second filtered lists based on a determined affinity of the recipient 102a towards each product included in the first and second filtered lists. In other words, the first and second filtered lists may be re-ordered based on the determined affinity of the first user 102a towards each product included in the first and second filtered lists. The recommendation server 110 communicates the first and second filtered lists to the second and third user devices 104b and 104c, respectively. At step 912, the recommendation server 110 renders the first UI on the second and third user devices 104b and 104c by way of the service application 114 that runs on the second and third user devices 104b and 104c. The first UI rendered on each of the second and third user devices 104b and 104c may display the first and second filtered lists, respectively. The one or more products in the displayed the first and second filtered lists may be selectable by the first and second senders 102b and 102c. The first and second senders 102b and 102c may select, for presenting to the recipient 102a, the first and second products from the first and second filtered lists, respectively. At step 914, the recommendation server 110 receives, from the second and third user devices 104b and 104c, the selections of the first and second products by the respective first and second senders 102b and 102c.

At step 916, the recommendation server 110 enables, by redirecting control to the second UI, the first and second senders 102b and 102c to purchase the selected first and second products (as described in the foregoing description of FIG. 4B). At step 918, the recommendation server 110 may present the purchased first and second products to the first user 102a (i.e., the recipient 102a). The recommendation server 110 may facilitate delivery of the first and second products to the address of the first user 102a. In another embodiment, the recommendation server 110 may facilitate delivery of the first and second products to corresponding addresses of the first and second senders 102b and 102c, respectively. In another embodiment, where one of the first and second products is a voucher or a coupon, the recommendation server 110 may communicate a coupon code or a voucher code of a corresponding voucher or coupon to the first user device 104a by way of a notification.

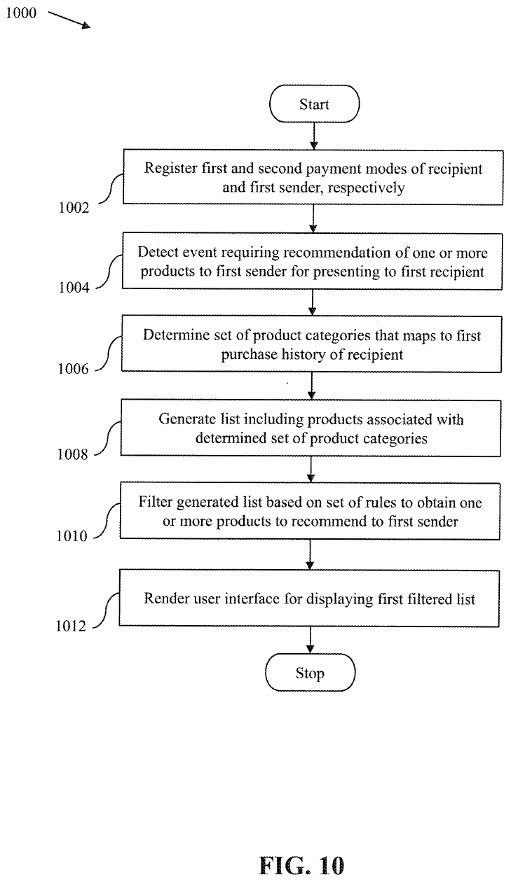

FIG. 10 represents a high-level flow chart 1000 that illustrates the method for recommending one or more products to the first sender 102b for presenting to the recipient 102a, in accordance with an exemplary embodiment of the present disclosure. At step 1002, the recommendation server 110 registers the first and second payment modes of the recipient 102a and the first sender 102b, respectively, with the service application 114 hosted by the recommendation server 110. The first and second payment modes are associated with first and second purchase histories of the recipient 102a and the first sender 102b, respectively. At step 1004, the recommendation server 110 detects an upcoming event (e.g., birthday of the recipient 102a) that requires recommendation of one or more products to the first sender 102b for presenting to the recipient 102a. At step 1006, the recommendation server 110, upon the detection of the event, determines a set of product categories that maps to the first purchase history. The first purchase history is indicative of the plurality of products purchased by the recipient 102a. At step 1008, the recommendation server 110 generates the list of products. The list of products includes products that are associated with the determined set of product categories. At step 1010, the recommendation server 110 filters the generated list of products based on the set of rules to obtain the first filtered list. The first filtered list is indicative of the one or more products for recommending to the first sender 102b for presenting to the recipient 102a. At step 1012, the recommendation server 110 renders the first UI on the second user device 104b for displaying the first filtered list. The first UI is rendered by way of the service application 114 that is executed on the second user device 104b. The one or more products included in the displayed filtered list are selectable by the first sender 102b for presenting to the recipient 102a.

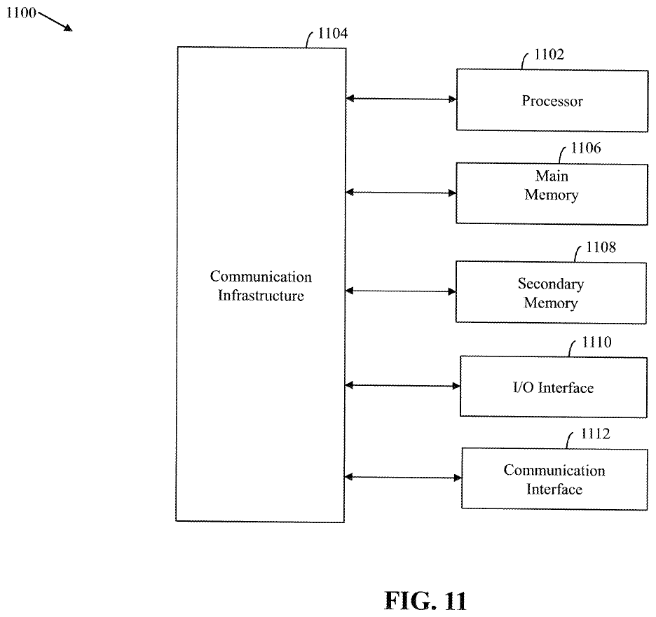

FIG. 11 is a block diagram that illustrates system architecture of a computer system 1100, in accordance with an exemplary embodiment of the present disclosure. An exemplary embodiment of the present disclosure, or portions thereof, may be implemented as computer readable code on the computer system 1100. In one example, the user devices 104, the issuer server 106, the merchant servers 108, and the recommendation server 110 of FIG. 1 may be implemented in the computer system 1100. Hardware, software, or any combination thereof may embody modules and components used to implement the methods of FIGS. 8, 9A-9C, and 10.

The computer system 1100 includes a processor 1102 that may be a special-purpose or a general-purpose processing device. The processor 1102 may be a single processor, multiple processors, or combinations thereof. The processor 1102 may have one or more processor cores. In one example, the processor 1102 is an octa-core processor. The processor 1102 may be connected to a communication infrastructure 1104, such as a bus, message queue, multi-core message-passing scheme, and the like. The computer system 1100 may further include a main memory 1106 and a secondary memory 1108. Examples of the main memory 1106 may include RAM, ROM, and the like. The secondary memory 1108 may include a hard disk drive or a removable storage drive, such as a floppy disk drive, a magnetic tape drive, a compact disc, an optical disk drive, a flash memory, and the like.

The computer system 1100 further includes an input/output (I/O) interface 1110 and a communication interface 1112. The I/O interface 1110 includes various input and output devices that are configured to communicate with the processor 1102. Examples of the input devices may include a keyboard, a mouse, a joystick, a touchscreen, a microphone, and the like. Examples of the output devices may include a display screen, a speaker, headphones, and the like. The communication interface 1112 may be configured to allow data to be transferred between the computer system 1100 and various devices that are communicatively coupled to the computer system 1100. Examples of the communication interface 1112 may include a modem, a network interface, i.e., an Ethernet card, a communication port, and the like. Data transferred via the communication interface 1112 may correspond to signals, such as electronic, electromagnetic, optical, or other signals as will be apparent to a person skilled in the art. The signals may travel via a communication channel (not shown) which may be configured to transmit the signals to devices that are communicatively coupled to the computer system 1100. Examples of the communication channel may include, but are not limited to, cable, fiber optics, a phone line, a cellular phone link, a radio frequency link, and the like.

The main memory 1106 and the secondary memory 1108 may refer to non-transitory computer readable mediums. These to non-transitory computer readable mediums may provide data that enables the computer system 1100 to implement the methods illustrated in FIGS. 8, 9A-9C, and 10. In an embodiment, the present disclosure is implemented using a computer implemented application, the computer implemented application may be stored in the main memory 1106 and/or the secondary memory 1108.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into digitally any device. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Thus, the environment 100 offers a convenient means for recommending products to senders (e.g., the first and second senders 102b and 102c) for purchasing and presenting to a recipient (e.g., the recipient 102a). The recommendation server 110 may learn an actual purchase history (e.g., the first purchase history) of the recipient and predict, using artificial intelligence, products that may be presented to the recipient. By filtering the generated list based on the set of rules, the recommendation server 110 maximizes relevancy of the recommended products for the recipient. Using a combination of various rules, the recommendation server 110 may provide, to each sender, product recommendations that suit a spending capacity of the sender, thus personalizing product recommendations for each sender as well. Technological improvements in the recommendation server 110 enable the recommendation server 110 to access the actual purchase histories of the recipient and the senders. Since the recommendation server 110 has access to the actual purchase histories of the registered senders and recipient, the recommendation server 110 takes into account products that have already been purchased by the recipient or gifted to the recipient, thus, preventing duplicate gifting to the recipient. Further, the purchase history (e.g., the first purchase history) of the recipient may be accessed only by the recommendation server 110, not by any other user or merchant. Thus, privacy of each user registered with the recommendation server 110 is safeguarded.

Techniques consistent with the present disclosure provide, among other features, systems and methods for recommending one or more products to a sender for presenting to a recipient. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

1. A method for recommending one or more products to a first sender for presenting to a recipient, the method comprising:
registering, by a server, first and second payment modes of the first sender and the recipient, respectively, with a service application hosted by the server, wherein the first and second payment modes are associated with first and second purchase histories of the first sender and the recipient, respectively;
detecting, by the server, an event requiring recommendation of the one or more products to the first sender for presenting to the recipient;
determining, by the server upon the detection, a set of product categories that maps to the second purchase history, wherein the second purchase history of the recipient indicates a first plurality of products purchased by the recipient;
generating, by the server, a list including a second plurality of products that are associated with the determined set of product categories;
filtering, by the server, the generated list based on a set of rules to obtain the one or more products for recommending to the first sender, wherein one of the set of rules pertains to exclusion of the first plurality of products from the generated list; and
rendering, by the server, a user interface on a first user device of the first sender for displaying the filtered list including the one or more products, wherein the displayed one or more products are selectable by the first sender for presenting to the recipient.

2. The method of claim 1, further comprising:
creating, by the server, first and second virtual accounts for the first sender and the recipient, respectively, to allow the first sender and the recipient to access the service application;
adding, by the server, the first and second payment modes to the first and second virtual accounts, respectively, for the registration; and
linking, by the server, the second virtual account to the first virtual account based on a permission granted by the recipient, wherein, based on the linking, the second purchase history is accessible to the server for recommending the one or more products to the first sender.

3. The method of claim 1, wherein determining the set of product categories comprises:
identifying, by the server, a plurality of product categories associated with the second purchase history, wherein each of the identified plurality of product categories corresponds to a product included in the second purchase history; and
filtering, by the server, to obtain the set of product categories, the identified plurality of product categories based on a frequency of purchase by the recipient with respect to each of the identified plurality of product categories, wherein the identified plurality of product categories are filtered by excluding one or more product categories for which the frequency of purchase by the recipient is above a first threshold or below a second threshold.

4. The method of claim 1, further comprising determining, by the server, a spending capacity of the first sender based on the first purchase history, wherein one of the set of rules pertains to the spending capacity of the first sender such that a first set of products, included in the generated list, is further excluded to obtain the filtered list when a price of each of the first set of products exceeds the spending capacity.

5. The method of claim 1, further comprising determining, by the server, one or more merchant preferences of the first sender and the recipient based on the first and second purchase histories, wherein one of the set of rules pertains to the determined one or more merchant preferences such that the one or more products, in the generated list, that conform to the determined one or more merchant preferences are included in the filtered list.

6. The method of claim 1, further comprising:
identifying, by the server, a geographic location of the recipient; and
determining, by the server, a relevancy score between the identified geographic location and each of the second plurality of products, wherein one of the set of rules pertains to the determined relevancy score such that a second set of products, included in the generated list, is excluded to obtain the filtered list when the relevancy score of each of the second set of products is below a third threshold.

7. The method of claim 1, further comprising identifying, by the server, a virtual wishlist that is indicative of a third set of products preferred by the recipient, wherein one of the set of rules pertains to the virtual wishlist such that the filtered list includes the third set of products.

8. The method of claim 1, further comprising modifying, by the server, the displayed filtered list based on a third plurality of products that are purchased by one or more other senders for presenting to the recipient after the filtered list is displayed on the first user device, wherein, for the modification, the third plurality of products are removed from the displayed filtered list in real time.

9. The method of claim 1, further comprising ranking, by the server, the one or more products in the filtered list based on an affinity of the recipient towards each of the one or more products, wherein the affinity is determined based on the second purchase history, and wherein the filtered list is displayed based on the ranking.

10. The method of claim 1, wherein the one or more products that are recommended to the first sender for presenting to the recipient are different from one or more products that are recommended to a second sender for presenting to the recipient, when the first purchase history of the first sender is different from a third purchase history of the second sender.

11. A system for recommending one or more products to a first sender for presenting to a recipient, the system comprising:
a server that is configured to:
register first and second payment modes of the first sender and the recipient, respectively, with a service application hosted by the server, wherein the first and second payment modes are associated with first and second purchase histories of the first sender and the recipient, respectively,
detect an event requiring recommendation of the one or more products to the first sender for presenting to the recipient,
determine a set of product categories that maps to the second purchase history, wherein the second purchase history of the recipient indicates a first plurality of products purchased by the recipient,
generate a list including a second plurality of products that are associated with the determined set of product categories,
filter the generated list based on a set of rules to obtain the one or more products for recommending to the first sender, wherein one of the set of rules pertains to exclusion of the first plurality of products from the list, and
render a user interface on a first user device of the first sender for displaying the filtered list including the one or more products, wherein the displayed one or more products are selectable by the first sender for presenting to the recipient.

12. The system of claim 11, wherein the server is further configured to:
create first and second virtual accounts for the first sender and the recipient, respectively, to allow the first sender and the recipient to access the service application,
add the first and second payment modes to the first and second virtual accounts, respectively, for the registration, and
link the second virtual account to the first virtual account based on a permission granted by the recipient, wherein, based on the linking of the second virtual account to the first virtual account, the second purchase history is accessible to the server for recommending the one or more products to the first sender.

13. The system of claim 11, wherein, for determining the set of product categories, the server is further configured to:
identify a plurality of product categories associated with the second purchase history, wherein each of the identified plurality of product categories corresponds to a product included in the second purchase history, and
filter, to obtain the set of product categories, the identified plurality of product categories based on a frequency of purchase by the recipient with respect to each of the identified plurality of product categories, wherein the identified plurality of product categories are filtered by excluding one or more product categories for which the frequency of purchase by the recipient is above a first threshold or below a second threshold.

14. The system of claim 11, wherein the server is further configured to determine a spending capacity of the first sender based on the first purchase history, and wherein one of the set of rules pertains to the spending capacity of the first sender such that a first set of products, included in the generated list, is further excluded to obtain the filtered list when a price of each of the first set of products exceeds the spending capacity.

15. The system of claim 11, wherein the server is further configured to determine one or more merchant preferences of the first sender and the recipient based on the first and second purchase histories, and wherein one of the set of rules pertains to the determined one or more merchant preferences such that the one or more products, in the generated list, that conform to the determined one or more merchant preferences are included in the filtered list.

16. The system of claim 11, wherein the server is further configured to:
identify a geographic location of the recipient, and
determine a relevancy score between the identified geographic location and each of the second plurality of products, wherein one of the set of rules pertains to the determined relevancy score such that a second set of products, included in the generated list, is excluded to obtain the filtered list when the relevancy score of each of the second set of products is below a third threshold.

17. The system of claim 11, wherein the server is further configured to identify a virtual wishlist that is indicative of a third set of products preferred by the recipient, and wherein one of the set of rules pertains to the virtual wishlist such that the filtered list includes the third set of products.

18. The system of claim 11, wherein the server is further configured to modify the displayed filtered list based on a third plurality of products that are purchased by one or more other senders for presenting to the recipient after the filtered list is displayed on the first user device, and wherein, to modify the displayed filtered list, the third plurality of products are removed from the displayed filtered list in real time.

19. The system of claim 11, wherein the server is configured to rank the one or more products in the filtered list based on an affinity of the recipient towards each of the one or more products, wherein the affinity is determined is based on the second purchase history, and wherein the filtered list is displayed based on the ranking.

20. The system of claim 11, wherein the one or more products that are recommended to the first sender for presenting to the recipient are different from one or more products that are recommended to a second sender for presenting to the recipient, when the first purchase history of the first sender is different from a third purchase history of the second sender.
